(19) United States
(12) Patent Application Publication
(10) Pub. No.: US 2026/0208696 A1
(43) Pub. Date: Jul. 23, 2026

(54) SYSTEMS AND METHODS FOR ULTRA WIDEBAND-BASED LIFT AND TIRE DEFLATION DETECTION IN VEHICLES

(71) Applicant: Ford Global Technologies, LLC, Dearborn, MI (US)

(72) Inventors: Sanketh Venkatesh Prasad, Bloomington, IL (US); Sathyanarayana Chary Palakonda, Northville, MI (US); Ivan Vukovic, Birmingham, MI (US); Michael Goebelbecker, Plymouth, MI (US); Jean de Dieu Mutangana, Detroit, MI (US)

(73) Assignee: Ford Global Technologies, LLC, Dearborn, MI (US)

(21) Appl. No.: 19/032,733

(22) Filed: Jan. 21, 2025

(51) Int. Cl. B60R 25/31; B60R 25/30; B60R 25/34

(52) U.S. Cl. CPC B60R 25/31; B60R 25/305; B60R 25/34

(57) ABSTRACT

Systems and methods for determining unauthorized activity associated with a vehicle are provided. The vehicle includes one or more ultra-wideband (UWB) sensor units. If certain preconditions are met, the vehicle may enable a vehicle state detection feature. Upon activation of the feature and when the vehicle is resting on reference surface, the UWB sensor units measure a distance between themselves and the reference surface. The vehicle continuously monitors this distance. At any point in time, if the vehicle determines that the distance has increased beyond a threshold, the vehicle may infer that the vehicle is being lifted above the reference surface and some unauthorized activity, such as tire theft, is likely occurring. The vehicle may then activate one or more external cameras of the vehicle to capture audio-video of the unauthorized activity, generate a notification, and send the notification and the audio-video to a user device associated with the vehicle.

### CROSS-REFERENCE TO RELATED APPLICATIONS

This application is related to U.S. patent application Ser. No. 18/149,580, filed on Jan. 3, 2023, and titled “Systems and Methods for Ultra Wideband-based Inclination Sensing,” the disclosure of which is incorporated in its entirety herein for all purposes.

### FIELD

The present disclosure relates to the field of detection of lift sensing. Specifically, embodiments of the present disclosure relate to systems and methods that use ultra-wideband radar and/or tire pressure sensors for detecting whether a vehicle is being lifted and/or one or more tires of the vehicle are currently deflated.

### BACKGROUND

Tire theft in vehicles is a common occurrence. Often, the perpetrators may jack the entire vehicle and then remove the tires. The inertial sensors in the vehicle, even if present, may not be able to detect such an action. In other instances, the perpetrators may use cinder blocks to lift hold up a vehicle and then deflate the tires prior to tire removal. In many instances, the existing tire pressure monitoring sensors may not be able to detect the tire deflation for various reasons, such as the vehicle being in an ignition off state.

In other instances, the tire pressure sensors may have a low refresh rate, thereby delaying the data gathered and reported by these sensors. Also, in some cases, the tire pressure sensors may report pressure data only after the vehicle has been driven for a specific period of time after being at rest for a while. In these instances, the data from the tire pressure sensors may not be available in time to detect the tire deflation or theft.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3. a schematic of a vehicle that shows the various sensors used to implement embodiments of the present disclosure.

FIG. 4. a schematic block diagram of a system for detecting vehicle lift and tire deflation according to an embodiment of the present disclosure.

FIGS. 5A and 5B illustrate details of a method of using angle of arrival information for determining whether a vehicle is being lifted above a reference surface, according to an embodiment of the present disclosure.

FIGS. 6A and 6B illustrate a method of using ultra-wideband time-of-flight data to determine whether a vehicle is being lifted above a reference surface, according to an embodiment of the present disclosure.

FIGS. 7A and 7B illustrate a method for determining tire deflation using ultra-wideband radar signals according to an embodiment of the present disclosure.

FIG. 8 illustrates a flow chart of a process according to an embodiment of the present disclosure.

FIG. 9 illustrates a block diagram of a server according to an embodiment of the present disclosure.

### DETAILED DESCRIPTION

### Overview

The present disclosure describes systems and methods for detecting whether a vehicle has been lifted above a ground or a reference surface, using ultra-wideband radar sensors. The systems and methods further include using ultra-wideband radar sensors alone or in conjunction with tire pressure monitoring sensors to detect tire deflation.

Embodiments of the present disclosure provide a method for determining whether a vehicle is being tampered with, such as being lifted above a surface for tire removal. The method includes determining, by a controller of a vehicle, that a set of preconditions are satisfied. Based on that, the controller enables a vehicle state detection feature. Upon enabling the vehicle state detection feature, the method then includes the controller determining, at a first time, a first distance between an ultra-wideband (UWB) unit of the vehicle and a reference surface on which the vehicle is resting, determining at a second time after the first time, a second distance between the UWB unit and the reference surface, and determining, based on the first distance and the second distance, that the second distance is higher than a threshold. The method includes the controller further determining, based on the second distance being higher than the threshold and the set of preconditions being satisfied, that the vehicle is positioned vertically above the reference surface, and generating a notification indicating occurrence of an unauthorized activity associated with the vehicle.

In another instance, a vehicle is provided. The vehicle includes a controller, one or more ultra-wideband (UWB) radar units coupled to the controller, and a memory device coupled to the controller and including instructions. The controller may execute the instructions to determine that a set of preconditions are satisfied, determine, at a first time and in response to the set of preconditions being satisfied, a first distance between a first UWB radar unit, of the one or more UWB radar units, and a reference surface on which the vehicle is resting. The controller may further determine, at a second time after the first time and in response to the set of preconditions being satisfied, a second distance between the first UWB radar unit and the reference surface, and determine based on the first distance and the second distance, that the second distance is higher than a threshold. Thereafter, the controller may determine, based on the second distance being higher than the threshold, that the vehicle is positioned vertically above the reference surface, and generate a notification indicating occurrence of an unauthorized activity associated with the vehicle.

In yet another instance, another method for determining deflation of vehicle tires is provided. The method includes determining, by a controller of a vehicle, that a set of preconditions are satisfied, wherein the set of preconditions include a vehicle ignition of the vehicle being in an off state, all doors of the vehicle being in a closed state, all doors of the vehicle being in a locked state, and a user device associated with the vehicle being more than a threshold distance away from the vehicle. The method further includes determining, at a first time, first data from an ultra-wideband (UWB) radar unit of the vehicle, the first data indicative of a first distance between the UWB radar unit and a reference surface on which the vehicle is resting. The method further includes the controller determining, at a second time after the first time, second data from the UWB radar unit, the second data indicative of a second distance between the UWB radar unit and the reference surface, and determining that the second distance is less than the first distance. The method then includes the controller determining, based on the second distance being less than the first distance, that one or more tires of the vehicle are in a deflated state.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

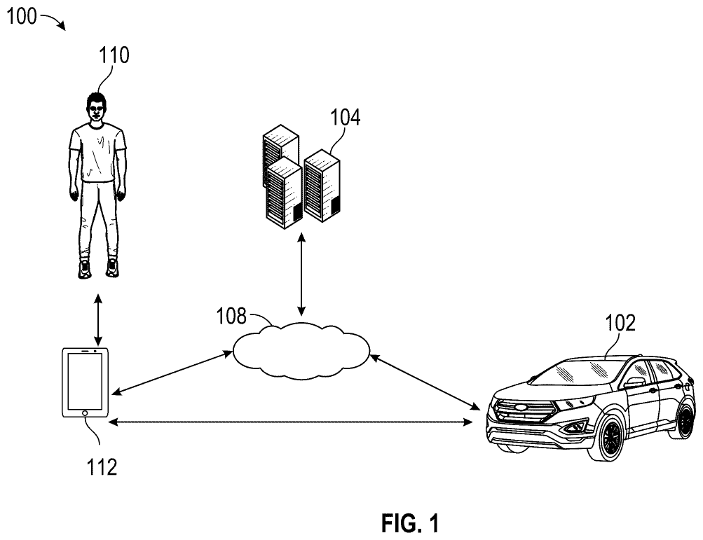

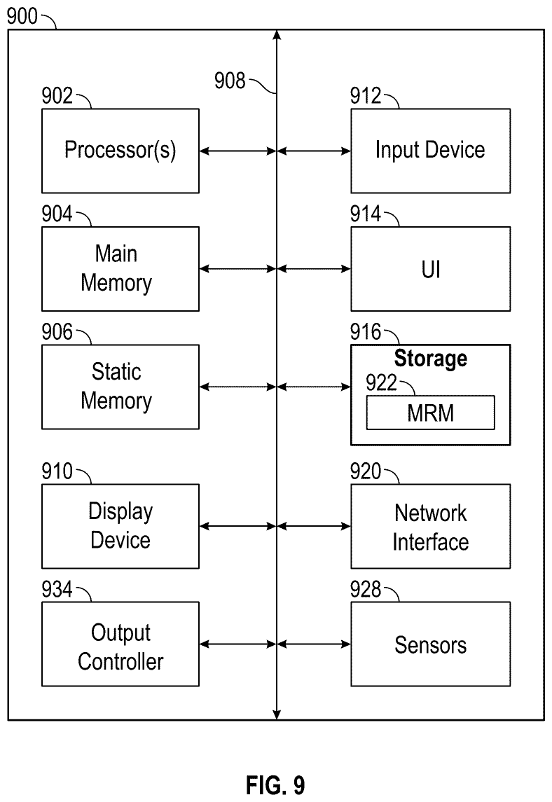

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 9.

The environment 100 may also include a user device 112. The user device 112 may be one of a mobile phone, a tablet, a personal computer, a smart key fob, smart watch, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

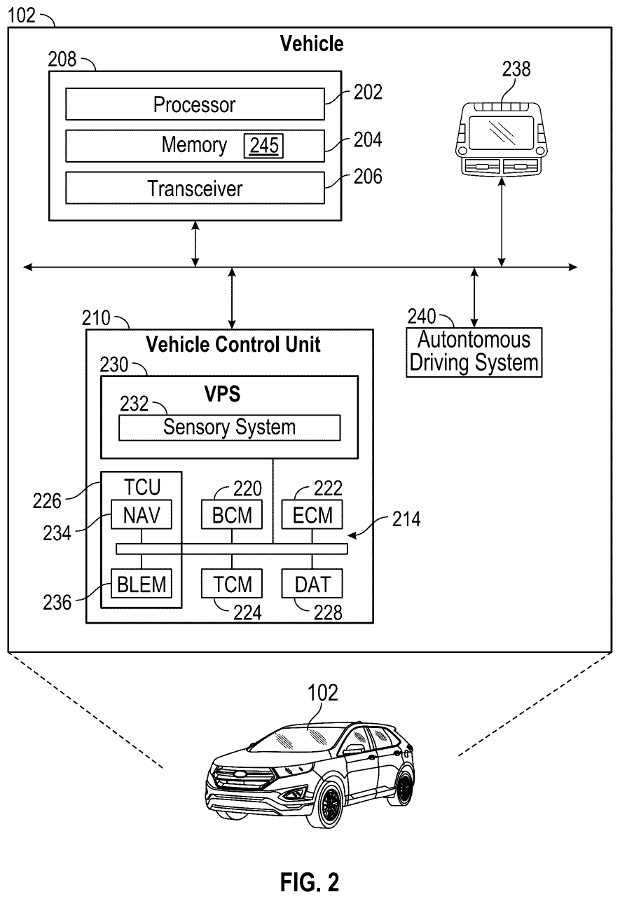

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the Body Control Module (BCM) 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc., on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

There are various existing tilt detection mechanisms in vehicles. The existing tilt detection systems are designed to detect any substantial change in the angle or inclination of the vehicle. Tilt detectors monitor the orientation (angle) of a vehicle relative to a reference point (usually the ground). If the vehicle tilts beyond a set threshold, the system may trigger an alert.

The current tilt sensors may suffer from issues such as causing false alarms due to vibrations (e.g., a large vehicle passing by, strong wind gusts, etc.), earthquakes, vehicle parked on a sloped road, etc. Further some tilt sensors may suffer from limited detection angles (e.g., only detect x-y horizontal tilt). Embodiments of the present disclosure mitigate these and other issues that may exist in the current tilt detection systems.

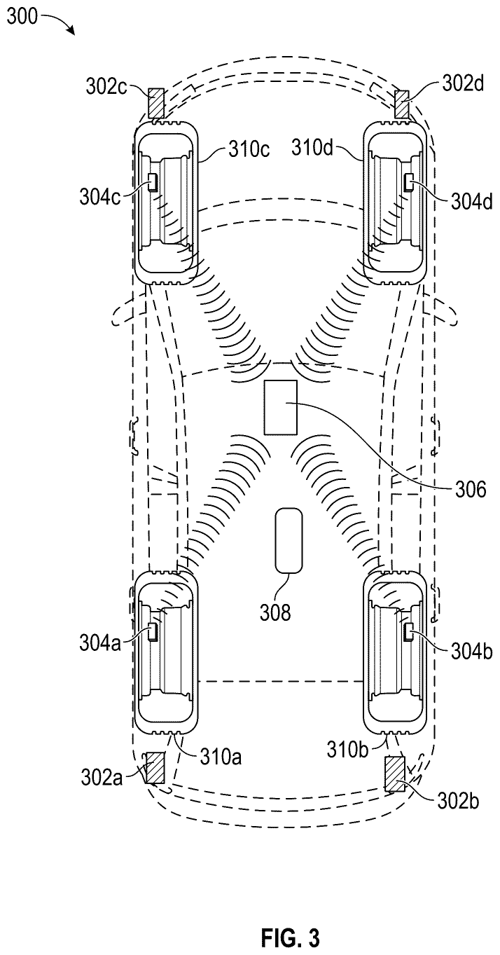

FIG. 3 illustrates a schematic of a vehicle 300 that shows the various sensors used to implement embodiments of the present disclosure. The vehicle 300 may be implemented using vehicle 102 of FIG. 2. The vehicle 300 may include multiple UWB sensor units 302a-302d. In some embodiments, each UWB unit 302 may include a UWB transmitter and a UWB receiver. A UWB transmitter is a device that generates and emits UWB pulses (ultra-short pulses) over a wide range of frequencies. Unlike traditional narrowband radio signals, UWB signals have a very wide bandwidth (greater than 500 MHz) but are transmitted at very low power, which minimizes interference with other devices. A UWB receiver is a device that listens for and detects the ultra-short UWB pulses sent by the UWB transmitter. It analyzes the timing, frequency, and other characteristics of the received pulses to extract information or calculate the position of the transmitting device. In other embodiments, a pair of UWB units (e.g., 302a and 302c) can operate as a transmitter and receiver pair. In this instance, one UWB unit 302a can act as a UWB transmitter, and the other UWB unit 302c can act as a UWB receiver. The UWB units 302a-302d may be located at the corners of the vehicle 300 (e.g., one at each corner of the vehicle 300). In general, it is preferable for the UWB units 302 to be as spaced apart as possible. Obviously, the location and spacing of the UWB units 302 will depend on the vehicle shape and size.

The vehicle 300 may further include a plurality of tire pressure monitoring system (TPMS) units 304a-304d. In an embodiment, a single TMPS unit 304 may be associated with an individual tire 310 of the tires 310a-310d. Each TPMS unit 304 may include a pressure sensor, a temperature sensor, a radio frequency (RF) transmitter, and a power source. Each TPMS unit 304 may communicate with a vehicle ECU/TCU 306. The pressure sensor and the temperature sensor within each TPMS unit 304 measure the tire pressure and temperature and report those values to the ECU/TCU 306 via the RF transmitter. If the measured pressure falls below a designated threshold, the TCU/ECU may generate a notification alerting the driver of the low tire pressure. The vehicle 300 may further include a controller 308 that receives data from the UWB units 302 and the ECU/TCU 306. The controller 308 may include programming that can use the data from the UWB units and/or the TMPS units 304 to determine whether the vehicle 300 has been lifted beyond a threshold above a reference surface/plane or whether the tires 310 of the vehicle 300 are currently deflated.

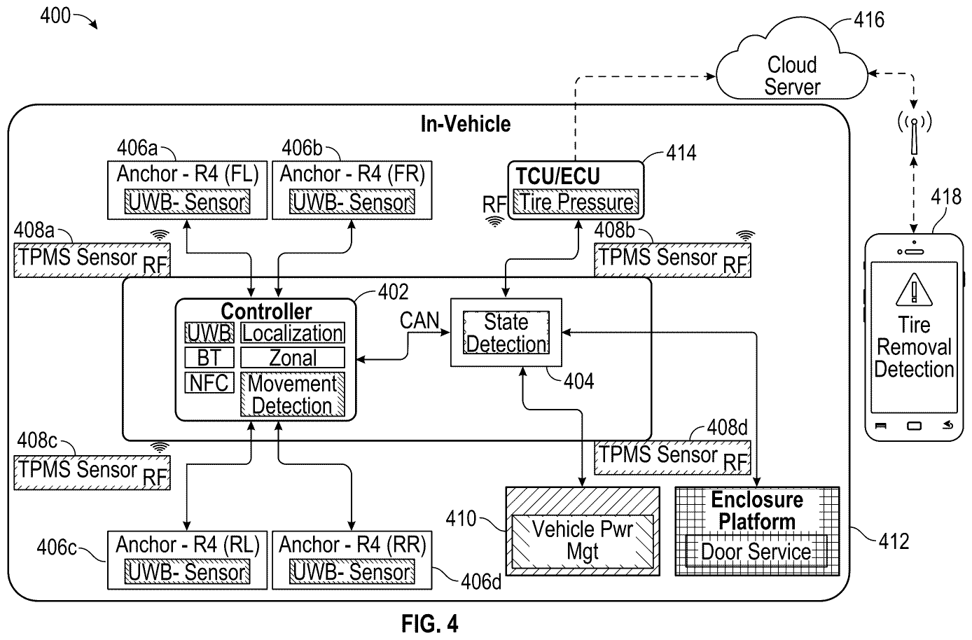

FIG. 4 illustrates a schematic block diagram of a system 400 for detecting vehicle lift and tire deflation according to an embodiment of the present disclosure. The system 400 can be implemented in the vehicle 102 or 300 and/or the server 104. The system 400 includes a controller unit 402. The controller unit 402 receives data from the UWB sensor units 406a-406d and any other inertial measurement units (IMUs) that the vehicle may include. For example, the vehicle may include IMUs such as single or multi-axis accelerometers, gyroscopes, magnetometers, or combinations thereof. In an embodiment, the controller unit 402 may be implemented as an ECU/TCU of the vehicle. The system 400 may further include a vehicle state detection unit 404. The vehicle state detection unit 404 includes algorithms and programming that can determine whether the vehicle is being lifted, whether one or more tires of the vehicle are deflated, any movement around the vehicle, and/or if the vehicle is being tampered with in any way (e.g., wheel lugs being removed). In an embodiment, the vehicle state detection unit 404 may be implemented as a TCU/ECU of the vehicle or within the module 245 of the memory 204. The vehicle state detection unit 404 may also receive data from a tire pressure monitoring TCU 414. The tire pressure monitoring TCU 414 may be wirelessly coupled to one or more TPMS units 408a-408d. In addition, the vehicle state detection unit 404 is also communicably coupled to a vehicle power management unit 410. The vehicle power management unit may provide data regarding the vehicle's current power state to the vehicle state detection unit 404 (e.g., whether ignition is on or off, etc.). The vehicle state detection unit 404 may also receive input from the vehicle enclosure platform 412 regarding the current status of the one or more doors and windows of the vehicle. The vehicle state detection unit 404 receives inputs/data from these various units and compares the data with respective thresholds to determine whether the vehicle is being lifted above a reference surface (e.g., a ground surface) and/or whether any of the vehicle tires are deflated. In some embodiments, the vehicle state detection unit 404 and the controller unit 402 may be implemented in a single ECU or TCU.

The system 400 may be communicably coupled to a back-end server 416 (e.g., server 104 of FIG. 1). The system 400 may communicate data and notifications to a user device 418 (e.g., user device 112 of FIG. 1) via the back-end server 416. In operation, if the system 400 determines that the vehicle is being lifted and/or there is some unauthorized activity in progress with regards to the tires, the system may send an alert notification to the user device 418 so that the user may then take an appropriate action.

There are several ways in which the UWB units can be used to determine whether a vehicle is being lifted above a reference surface, detect presence of unauthorized humans around the vehicle, and determine state of the tire inflation of each of the tires of the vehicle.

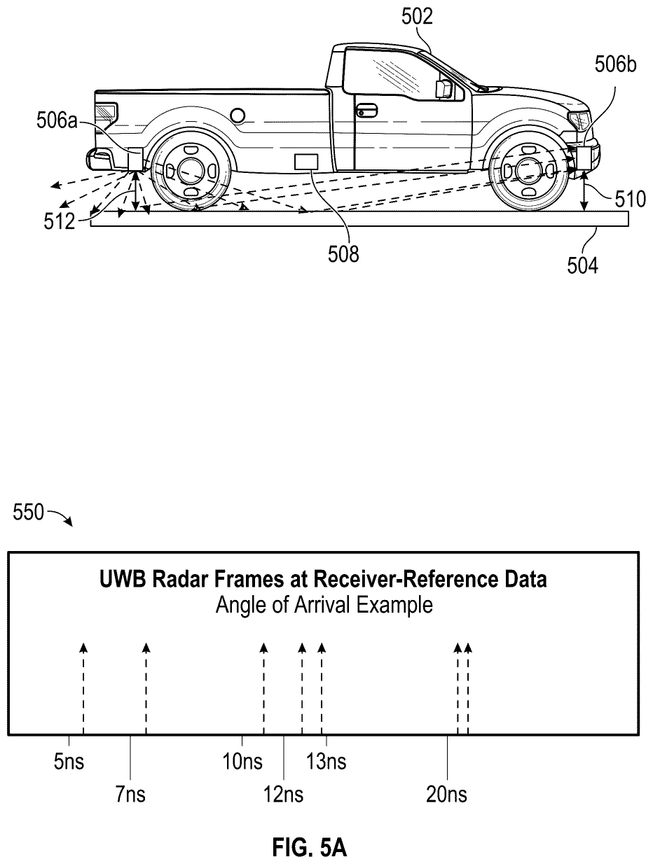

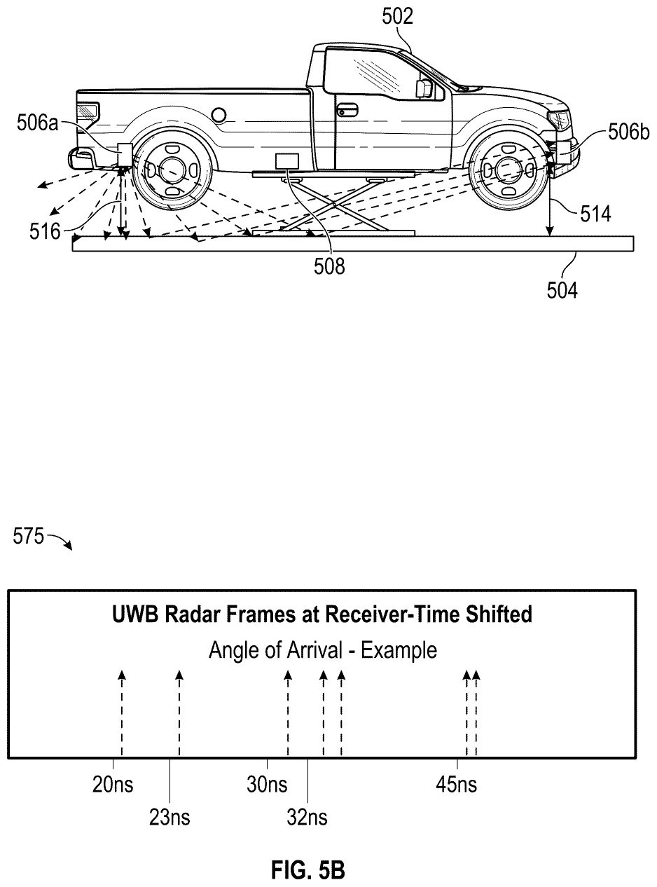

FIG. 5A illustrates details of a method for determining whether a vehicle is being lifted above a reference surface according to an embodiment of the present disclosure. For example, the vehicle state detection unit 404 may perform the method based on data received from the UWB sensors and other vehicle systems as described above. In this embodiment, a vehicle 502 includes a UWB transmitter 506a and a UWB receiver 506b coupled at two ends of the vehicle 502. FIG. 5A illustrates a view of one side of the vehicle 502. It is to be understood that the opposite side of the vehicle 502 includes a second pair of UWB transmitter and receiver (not shown). The method used data gathered by both pairs of the UWB transmitter and receiver. In this embodiment, the vehicle 502 uses the UWB Angle of Arrival (AoA) information to determine a vertical distance between the vehicle 502 and a reference surface 504. In an embodiment, the reference surface 504 can be a ground surface or a road. In other embodiments, the reference surface 504 can be any surface that the vehicle is resting on at any given time (e.g., a floor of a multi-story parking garage).

The Angle or Arrival refers to the angle at which a signal transmitted from the UWB transmitter 506a arrives at the UWB receiver 506b. This angle is measured relative to a reference direction (e.g., north or the orientation of the UWB receiver 506b). The UWB receiver 506b may include multiple antennas. The UWB transmitter emits multiple signals towards the reference surface 504. Each of the multiple signals reflect off the reference surface 504 and are detected by the UWB receiver 506b. When the UWB signal arrives at each of the multiple antennas the slight time delay in the signal's arrival at each antenna is measured. This delay creates a phase shift in the signal, which is used to calculate the AoA. Thus, the phase or time difference of signal arriving at each antenna of the UWB receiver 506b is used to calculate the angle of the incoming signal (i.e., AoA). In this manner, each UWB receiver of the vehicle calculates the AoA from a respective UWB transmitter. Since the position of each of the UWB receivers is known, that information, along with the AoA measurement, can then be used to compute the distance between the UWB transmitter 506a and the reference surface 504 using triangulation technique.

In another embodiment, the UWB receiver 506b may also measure the Time of Flight (ToF) value to determine a distance between the UWB transmitter 506a and the reference surface 504. The graph 550 illustrates the time difference of the UWB signal arriving at the UWB receiver 506b over a period of time. As can be seen in the example of FIG. 5A, the time difference of arrival of the UWB signals ranges between 5 nanoseconds (ns) and 20 ns. Since the vehicle 502 is resting on the reference surface 504, the data illustrated in graph 550 may represent reference data for a given measurement or monitoring session. Any variation in the data measured after measuring the reference data may be an indication that the vehicle is being tampered with in some manner. Thus, distances 510 and 512 represent reference data, which is illustrated in the graph 550.

FIG. 5B illustrates an example in which the vehicle is being lifted above the reference surface 504. For example, the vehicle state detection unit 404 may perform the method/calculations based on data received from the UWB sensors and other vehicle systems to determine if the vehicle is being lifted above the reference surface. If the vehicle 502 is lifted above the reference surface 504, the AoA information for the UWB signals emitted by the UWB transmitter 506a and received by the UWB receiver 506b changes. Specifically, the time difference of the signals reflected from the reference surface 504 will increase since the signals now have to travel a longer distance 514 or 516, to reach the reference surface 504 compared to the distances 510 and 512 in FIG. 5A above. The graph 575 illustrates the change in the time difference of signals. For example, the time difference values of the signals now range between 20 ns and 45 ns. These values can be used to determine that the vehicle is likely being lifted above the reference surface 504. If the change in the time difference values is above a threshold, the vehicle can be configured to send a notification to the user of the vehicle 502. In some embodiments, the UWB AoA arrival data may be used along with the IMU sensor 508 data to further confirm whether the vehicle 502 is being lifted above the reference surface 504.

In some embodiments, each of the UWB unit 506a and 506b may be a transceiver that includes both a transmitter and a receiver. In this instance, the AoA data can also be used to determine a location of an activity around the vehicle. For example, consider that a person is positioned next to one of the tires of the vehicle 502 and is in the process of removing that tire. The signal emitted from the UWB transceiver closest to that tire will reflect off the person and will be captured by the UWB transceiver. Specifically, the UWB transmitter may send short, wideband pulses into the environment. The UWB receiver may capture reflected signal from the person. The vehicle may then determine the time it takes for the pulse to travel to the person and back. The vehicle may then detect changes in frequency of the signal caused by motion of the human (e.g., walking, breathing, etc.). Based on the received signal, a location of the person can be determined.

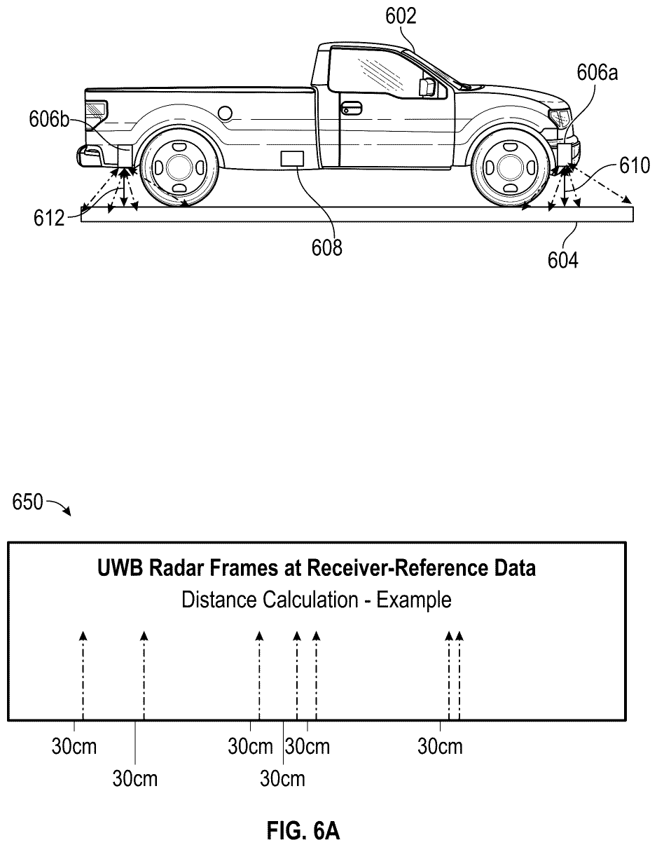

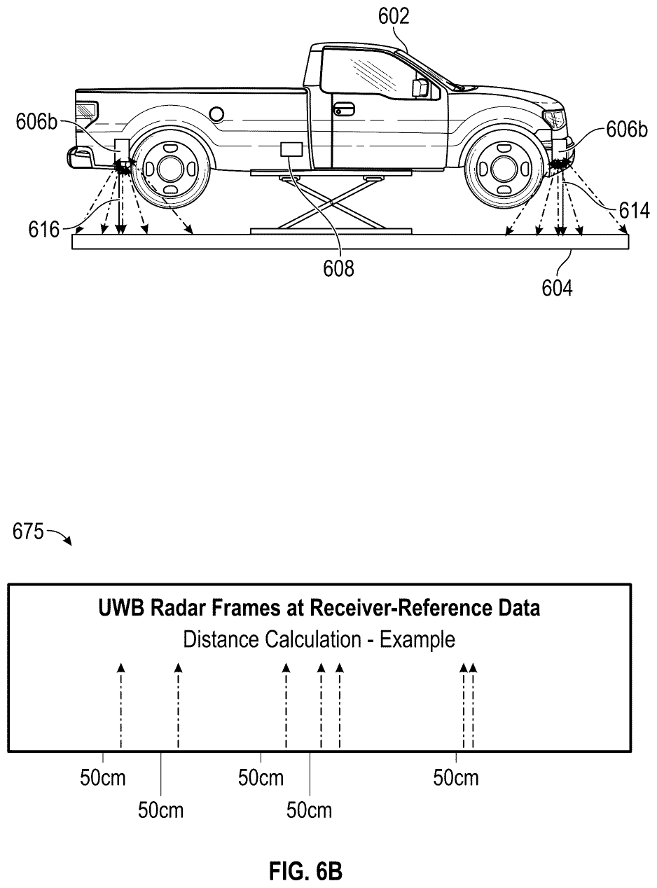

FIG. 6A illustrates an example of using UWB signals to determine a distance between the UWB unit and a reference surface according to an embodiment of the present disclosure. In an embodiment, the vehicle state detection unit 404 may perform the method/calculations based on data received from the UWB units and other vehicle system to determine distancer between the UWB unit and the reference surface. In this example, a vehicle 602 is resting on a reference surface 604. The vehicle 602 includes one or more UWB transceivers 606a and 606b. As explained above, a UWB transceiver includes both a UWB transmitter and a UWB receiver. The vehicle may also include an IMU sensor 608. In order to generate the reference data, each UWB transceiver 606a and 606b may emit UWB signal towards the reference surface 604. The UWB signal reflects off the reference surface 604 and the reflected signal is captured by the respective UWB transceiver. The vehicle then calculates the time of flight of the signal. As explained above, Time of Flight (ToF) refers to the total time taken by a signal to travel from the UWB transmitter to an object (reference surface 604 in our case) and from the object to the UWB receiver. The vehicle 602 may then calculate the distance between the UWB transceiver and the reference surface 604 using the formula

$$Distance = Speed of Light ( c ) \times Time of Flight ( ToF ) / 2 \qquad ( 1 )$$

The graph 650 illustrates the distance measurements of distances 610 and/or 612 over time between the UWB transceivers 606a and 606b and the reference surface 604. As illustrated in the graph 650, the reference distance is determined as being 30 cm. It is to be noted that the distance measurement shown in the graph 650 is exemplary and that the reference distance will depend on the size and shape of the vehicle 602.

FIG. 6B illustrates an instance where the vehicle 602 is vertically lifted above the reference surface 604. For example, the vehicle state detection unit 404 may perform the method/calculations based on data received from the UWB sensors and other vehicle systems to determine if the vehicle is being lifted above the reference surface. In this instance, the IMU sensor 608 may not be able to capture the change in the vehicle elevation since the entire vehicle has been lifted without tilting the vehicle in the horizontal direction. The UWB transceivers 606a and/or 606b may emit UWB signals towards the reference surface 604. In this instance, the signals will take a longer time to travel to the reference surface 604 and back to the UWB transceivers. In other words, the ToF in this instance will be larger than the ToF in the case of FIG. 6A above. Therefore, the calculated distances 614 and/or 616 will be larger than the distances 610 and/or 612. The graph 675 illustrates the newly calculated distances 614/616. As illustrated, the distance between the UWB transceiver(s) and the reference surface is now 50 cm, indicating that the vehicle is being lifted vertically above the reference surface 604. This information can then be used by the vehicle to determine that the vehicle is being jacked up, which, along with other information, can be used to determine that the vehicle is likely being tampered with, and a notification may be sent to the user of the vehicle 602.

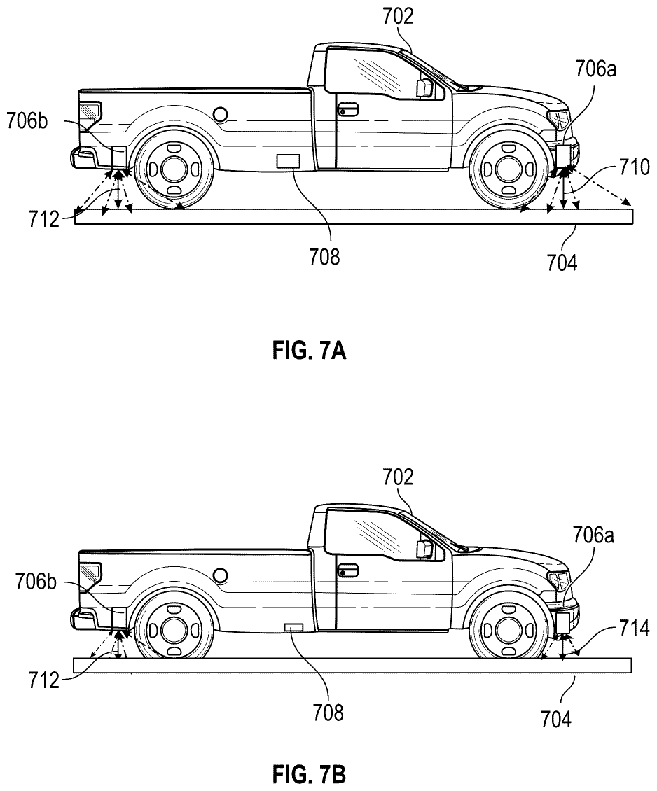

FIGS. 7A and 7B illustrate a process of using UWB sensor data to determine tire deflation of a vehicle according to an embodiment of the present invention. For example, the vehicle state detection unit 404 may perform the method/calculations based on data received from the UWB sensors and other vehicle sensors to determine if the vehicle tire is deflated. As noted above, in some instances, a TPMS sensor may not be able to report changes in tire pressure for various reasons, including low refresh rate, vehicle ignition being off, etc. In such cases, it may be hard to determine whether a tire is in a deflated state, either due to some issue with the tire or someone attempting to remove the tire by deflating the tire. In some embodiments, the UWB sensor data may be used in addition to the TPMS sensor data to determine tire deflation.

The vehicle 702 may include one or more UWB transceivers 706a and 706b and an IMU sensor 708. In FIG. 7A, the vehicle is resting on a reference surface 704, and vehicle can determine reference data for the tire inflation. Each of the UWB transceivers 706 may emit a UWB signal towards the reference surface 704 and use the ToF data to determine distance 710 and/or 712 between the UWB transceivers 706a and 706b and the reference surface 704. The distances 710 and/or 712 can be designated as reference distances when the tires of the vehicle 702 are properly inflated. If, for some reason, the tires are deflated or otherwise start losing air, the distance between the UWB transceivers 706 and the reference surface 704 will decrease. The UWB transceivers can monitor this distance over time to determine whether the distance has decreased. As, illustrated in FIG. 7B, the tires are in a deflated state, and as a result, the distances 714 and 716 are smaller than the distance 710 and 712. The vehicle can monitor these distances over time to determine whether the tires have been deflated. This data, along with other data such as presence of humans around the vehicle at the time of deflation, can help the vehicle determine whether the deflation is due to some issue with the tire or as a result of some foul play. In some instances, the distance measurement may also indicate an issue with the suspension of the vehicle.

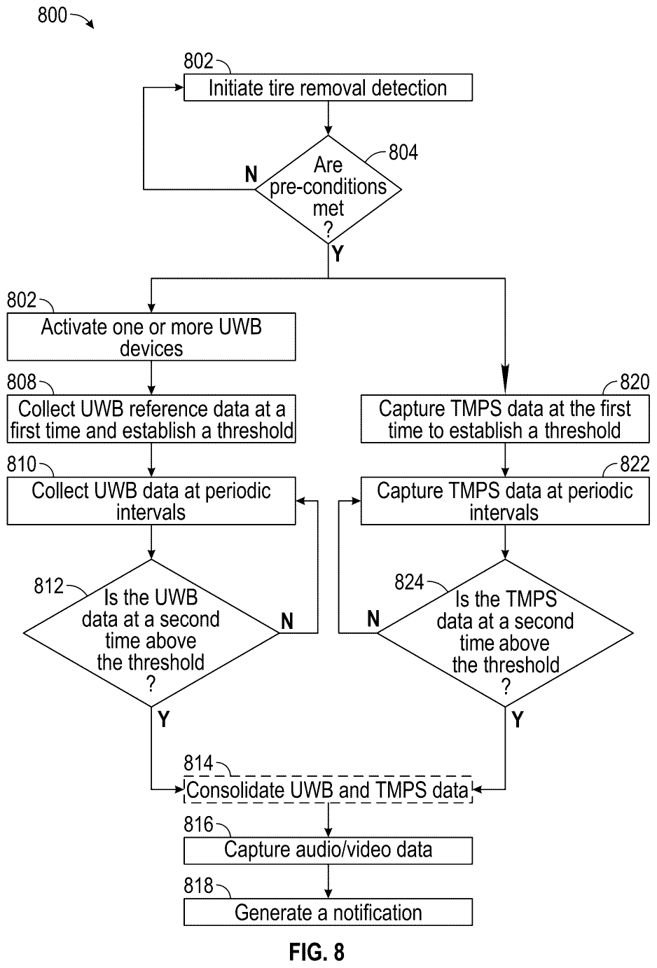

FIG. 8 illustrates a flow chart of a process 800 according to an embodiment of the present disclosure. Process 800 can be performed solely by the vehicle 102 or the vehicle 102 in conjunction with the server 104. For instance, the process 800 may be performed by the vehicle state detection system 404 in conjunction with the controller 402. At step 802 of the process 800, the vehicle may initiate the tire removal detection functionality of the vehicle. For example, the vehicle may initiate this functionality when the vehicle is stationary for a period of time. Next, at step 804, the vehicle may check whether a set of preconditions is currently met. The set of preconditions may include determination of whether the ignition is off, whether the doors of the vehicle are closed and locked, and whether an authorized user is not within a threshold distance of the vehicle. The distance of the authorized user may be determined based on a distance between a user device (e.g., a key fob or mobile device) associated with the authorized user and the vehicle. In an embodiment, the threshold distance may be 10 meters. If at step 804, it is determined that one or more of the set of preconditions are not met, the process returns to step 802, where the vehicle continues to monitor the status of the set of preconditions.

If, at step 804 it is determined that all of the preconditions in the set of preconditions are met, the vehicle may perform multiple actions. In an embodiment where the vehicle includes one or more UWB radar units, it may activate those UWB units at step 806 so that they can capture the UWB data mentioned above. At step 808, the vehicle may determine the baseline or reference measurements for the distance between the UWB units and the reference surface that the vehicle is resting on. For example, the vehicle may use the process described with reference to FIGS. 5A, 6A, and 7A above to establish the reference data at step 808. The reference data may include AoA data, distance data, and/or tire pressure data determined using the UWB units. This reference data may be stored in a memory of the vehicle. Once the reference data is determined at a first time, the vehicle may then periodically determine the distance data between one or more of the UWB units and the reference surface, the AoA data, and the tire pressure data, at step 810. The time interval for determining this data can be programmed by the user of the vehicle or it may be hardcoded into the vehicle programming. In an embodiment, the time interval may be between 5 mins and 10 mins. The periodically gathered data may be stored in a rolling buffer and compared with the reference data at step 812. If it is determined that data gathered at a second time, that is, after the first time, is not above a threshold, that data may be discarded, and the process 800 may return to step 810, where the vehicle continues to gather the UWB data.

If it is determined at step 812 that the data determined at the second time is above the respective threshold, the vehicle may determine that it is currently positioned/lifted above the reference surface, and as such, it is likely that the vehicle is being tampered with. In an embodiment, each item of data may have its respective threshold. For example, the AoA values, the distance values, and the tire pressure values may each have their respective distinct thresholds. The data determined at step 810 is compared against the appropriate threshold at step 812 to determine whether the data is above or below the threshold. Also, each of these thresholds may be individually programmable based on the type, size, and shape of the vehicle and the industry standards. In some embodiments, the absolute values of the distance measurements and/or the AoA values, and/or the tire pressure values determined at step 810 may be compared to the reference values determined at step 808. For example, consider that for a particular vehicle, it is determined at step 808 that the distance between UWB units and the reference surface is 30 cm. Then at step 810, if the same measured value is higher than 30 cm, then the vehicle may conclude that it is being lifted above the reference surface. In some embodiments, in order to prevent false indications, the vehicle may conclude that it is being lifted above the reference surface only if the difference in the distance between the reference value and the value determined at step 810 exceeds by certain value (e.g., 5 cm). Thus, in this instance, if the difference in distance value determined at step 810 is within 5 cm of the distance value determined at step 808, the vehicle will not generate any notification indicative of the vehicle being lifted above the reference surface. This may reduce the number of false notifications due to any transient events that might affect the distance between the UWB units and the reference surface.

At step 814, the results from the comparison of the UWB-related data are consolidated with data from the TPMS sensors of the vehicle. In the instance where the TMPS data is not available or if the vehicle does not have any TPMS sensors, step 814 can be skipped, and the process 800 can move directly to step 816 after step 812.

At step 816, the vehicle may activate one or more of its cameras to capture audio-video information of activity in the vicinity of the vehicle. If the vehicle determines that it is being vertically lifted above the reference surface and all of the pre-conditions are met, it is likely that someone may be attempting to tamper with the vehicle (e.g., remove the tires). The vehicle may then activate one or more of its external cameras to capture audio-video data of the environment around the vehicle. If someone is attempting to tamper with the vehicle, the vehicle may confirm such activity using the audio-video information. In some instances, the captured audio-video information may be used to identify the perpetrators and/or as documentary proof of the activity. At step 818, the vehicle may generate a notification regarding the event and send that notification to a use device of the user of the vehicle. For example, the notification may include a textual alert message that a potential tire removal might be in progress. In other embodiments, in addition to the textual message, the notification may also include audio-video data captured by the vehicle that shows the unauthorized tampering activity.

As noted above, in some instances, the tires of the vehicle may be deflated prior to removal. In vehicles that include TPMS sensors, the vehicle may also use data from the TPMS sensors to augment the data captured by the UWB sensors. Therefore, if the vehicle includes TPMS sensors, the vehicle may capture TPMS data at a first time after it determines that the preconditions are met, at step 804. At step 820, the vehicle captures TPMS data of one or more tires of the vehicle. This data can be designated as the reference data. Thereafter, the vehicle may capture TPMS sensor data at periodic intervals (step 822). The periodic intervals may be programmed by the user of the vehicle or can be hard-coded into the vehicle. At step 824, the TPMS data gathered at the periodic intervals is compared with the reference TPMS data captured at step 820. If it is determined that the TPMS data captured at a second time, that is, after the first time, is at or below a threshold, that data may be discarded, and the process 800 may return to the step 822 and continue to capture TPMS data at the set periodic intervals. The threshold in this instance may represent a difference in the pressure data captured at the first time and the second time. For example, consider that the TPMS data at the first time indicates a value of 33 pound per square inch (psi) (which may indicate normal tire pressure for the specific vehicle). Consider that, at the second time, the measured pressure data indicates a value of 31 psi. It is known that some amount of variation in tire pressure is common due to environmental factors and other reasons. So, a drop in the pressure by 2 psi likely does not indicate tire deflation. However, if the tire pressure measured at the second time indicates a value of 20 psi (i.e., a difference of 13 psi), then it is likely that the tire may be deflated. Thus, the vehicle may calculate a difference in the pressure values measured at the first time and the second time and then compare that difference value with the threshold to determine whether the tire is deflated or not, at step 824. So, in this example, the threshold may be set at somewhere between 5 psi and 15 psi. In another embodiment, the threshold may be set at a specific value, and if the measured pressure value at the second time is below this threshold, the vehicle may infer that the tire is in the deflated state. For example, the threshold may be set at 29 psi. So, if the measured pressure value at any given time falls below 29 psi, that tire may be considered as being deflated. This embodiment only measures the instantaneous pressure value and compares that against at threshold without regard for any prior pressure values.

In some embodiments, in response to determining that the TPMS difference data is above threshold, the vehicle may increase a rate at which the TPMS data is monitored (not shown). For instance, if the pressure is the tires is rapidly decreasing, it could indicate tire tampering, and in that instance, the vehicles may capture more samples of the TPMS data compared to a default sampling rate. This may enable the vehicle to quickly confirm whether the tire is indeed deflating.

If the TPMS data comparison at step 824 indicates tire deflation, that data may be consolidated with the UWB data at step 814, as discussed above. In some embodiments, UWB sensors may also be used to determine tire deflation, as explained above, in lieu of or in addition to the TPMS sensors. In such instances, the data captured by the UWB sensors may also be used to further determine whether the tires are deflated. It is to be noted that the various embodiments described above can also be used to determine/detect tire and/or vehicle suspension wear and tear over time.

FIG. 9 depicts a block diagram of an example control server 900 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 900 may operate as a standalone device or may be connected (e.g., networked) to other servers. In a networked deployment, the server 900 may operate in the capacity of a server machine, a client machine, or both in server-client network environments. In an example, the server 900 may act as a peer server in peer-to-peer (P2P) (or other distributed) network environments. The server 900 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The server 900 may further include a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The server 900 may additionally include a storage device (i.e., drive unit) 916, a network interface device/transceiver 920 coupled to antenna(s), and one or more sensors 928, such as a global positioning system (GPS) sensor, a compass, an accelerometer, or another sensor. The server 900 may include an output controller 934, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 916 may include a machine-readable medium 922 on which is stored one or more sets of data structures or instructions (e.g., software) embodying or utilized by any one or more of the techniques or functions described herein. The instructions may also reside, completely or at least partially, within the main memory 904, within the static memory 906, or within the hardware processor 902 during execution thereof by the server 900. In an example, one or any combination of the hardware processor 902, the main memory 904, the static memory 906, or the storage device 916 may constitute machine-readable media.

While the machine-readable medium 922 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM) random access memory (RAM), magnetic disk storage media, optical storage media; a flash memory, etc.

The term “machine-readable medium” may include any medium that is capable of storing, encoding, or carrying instructions for execution by the server 900 and that causes the server 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should also be understood that the word “example,” as used herein, is intended to be non-exclusionary and non-limiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a controller of a vehicle, that a set of preconditions are satisfied;
enabling, by the controller and based on the set of preconditions being met, a vehicle state detection feature;
determining, by the controller at a first time, a first distance between an ultra-wideband (UWB) unit of the vehicle and a reference surface on which the vehicle is resting;
determining, by the controller, at a second time after the first time, a second distance between the UWB unit and the reference surface;
determining, by the controller and based on the second distance, that the second distance is higher than a threshold;
determining, by the controller and based on the second distance being higher than the threshold and the set of preconditions being satisfied, that the vehicle is positioned vertically above the reference surface; and
generating, by the controller, a notification indicating occurrence of an unauthorized activity associated with the vehicle.

2. The method of claim 1, wherein the set of preconditions include:
a vehicle ignition of the vehicle being in an off state;
all doors of the vehicle being in a closed state;
all the doors of the vehicle being in a locked state; and
a user device associated with the vehicle being more than a threshold distance from the vehicle.

3. The method of claim 1, wherein the method further comprises, prior to generating the notification:
activating, by the controller, one or more cameras of the vehicle; and
capturing, using the one or more cameras, audio-video data of an environment in an immediate vicinity of the vehicle.

4. The method of claim 3, wherein the method further comprises: including the audio-video data in the notification, and sending the notification to a user device associated with a user of the vehicle.

5. The method of claim 1, further comprising:
determining, by the controller, a presence of a human around the vehicle; and
determining, by the controller and using one or more UWB units of the vehicle, a location of the human with respect to the vehicle, wherein the one or more UWB units including the UWB unit.

6. The method of claim 1, wherein the UWB unit is a first UWB unit, and determining the first distance further comprises:
determining, by the controller, an angle of arrival data between the first UWB unit and a second UWB unit of the vehicle wherein the first UWB unit is a receiver and the second UWB unit is a transmitter;
determining, by the controller, the first distance based on the angle of arrival data.

7. The method of claim 1, wherein determining the first distance further comprises:
determining, by the controller and using the UWB unit, time-of-flight data associated with a signal emitted by the UWB unit and a reflected signal received by the UWB unit; and
determining, by the controller, based on the time-of-flight data, the first distance.

8. The method of claim 1, wherein determining the first distance or the second distance further comprises:
determining, by the controller, angle of arrival data associated with the UWB unit;
determining, by the controller, a time-of-flight data associated with the UWB unit; and
determining, by the controller and using the angle of arrival data and the time-of-flight data, the first distance.

9. A vehicle comprising:
a controller;
one or more ultra-wideband (UWB) radar units coupled to the controller; and
a memory device coupled to the controller and including instructions, that when executed by the controller cause the controller to:
determine that a set of preconditions are satisfied;
determine, at a first time and in response to the set of preconditions being satisfied, a first distance between a first UWB radar unit, of the one or more UWB radar units, and a reference surface on which the vehicle is resting;
determine, at a second time after the first time and in response to the set of preconditions being satisfied, a second distance between the first UWB radar unit and the reference surface;
determine based on the second distance, that the second distance is higher than a threshold;
determine, based on the second distance being higher than the threshold, that the vehicle is positioned vertically above the reference surface; and
generate a notification indicating occurrence of an unauthorized activity associated with the vehicle.

10. The vehicle of claim 9, wherein to determine the first distance, the instructions further cause the controller to:
determine angle of arrival data associated with the first UWB radar unit;
determine time-of-flight data associated with the first UWB radar unit; and
determine, using the angle of arrival data and the time-of-flight data, the first distance.

11. The vehicle of claim 9, wherein the instructions further cause the controller to:
determine a presence of a human around the vehicle; and
determine, using the one or more UWB radar units, a location of the human with respect to the vehicle.

12. The vehicle of claim 9, wherein the set of preconditions include:
a vehicle ignition of the vehicle being in an off state;
all doors of the vehicle being in a closed state;
all the doors of the vehicle being in a locked state; and
a user device associated with the vehicle being more than a threshold distance away from the vehicle.

13. The vehicle of claim 9, wherein the instructions further cause the controller to:
activate one or more cameras of the vehicle;
capture, using the one or more cameras, audio-video data of an environment in an immediate vicinity of the vehicle; and
include the audio-video data in the notification.

14. The vehicle of claim 9, wherein to determine the first distance, the instructions further cause the controller to:
determine, using the first UWB radar unit, time-of-flight data associated with a signal emitted by the first UWB radar unit toward the reference surface and a reflected signal received by the first UWB radar unit from the reference surface; and
determine, based on the time-of-flight data, the first distance.

15. A method comprising:
determining, by a controller of a vehicle, that a set of preconditions are satisfied, wherein the set of preconditions include a vehicle ignition of the vehicle being in an off state, all doors of the vehicle being in a closed state, all the doors of the vehicle being in a locked state, and a user device associated with the vehicle being more than a threshold distance away from the vehicle;
determining, by the controller at a first time, first data from an ultra-wideband (UWB) radar unit of the vehicle, the first data indicative of a first distance between the UWB radar unit and a reference surface on which the vehicle is resting;
determining, by the controller at a second time after the first time, second data from the UWB radar unit, the second data indicative of a second distance between the UWB radar unit and the reference surface;
determining, by the controller, that the second distance is less than the first distance; and
determining, by the controller based on the second distance being less than the first distance, that one or more tires of the vehicle are in a deflated state.

16. The method of claim 15, further comprising:
determining, by the controller at the first time, third data from one or more tire pressure monitoring system (TPMS) sensors of the vehicle, the third data associated with the one or more tires of the vehicle;
determining, by the controller at the second time, fourth data from the one or more TPMS sensors, the fourth data associated with the one or more tires of the vehicle; and
wherein determining that the one or more tires of the vehicle are in a deflated state is further based on the third and the fourth data.

17. The method of claim 16, wherein the fourth data is lower than the third data.

18. The method of claim 15, wherein the vehicle includes a plurality of UWB radar units, the method further comprising:
determining, by the controller and using the plurality of UWB radar units, a presence of a person in a vicinity of the one or more tires; and
generating, by the controller, a notification indicating tampering with the vehicle.

19. The method of claim 18, further comprising, prior to generating the notification:
capturing, by the controller and using one or more cameras of the vehicle, audio-video data of an environment in a vicinity of the vehicle; and
including, by the controller, the audio-video data in the notification.

20. The method of claim 16, wherein the fourth data is lower than the third data by greater than a threshold value.
